(19) United States
(12) Patent Application Publication
(10) Pub. No.: US 2013/0221127 A1
(43) Pub. Date: Aug. 29, 2013

(54) LIQUID EJECTION APPARATUS

(71) Applicant: Shuichi TAMAKI, Nagoya-shi (JP)

(72) Inventor: Shuichi TAMAKI, Nagoya-shi (JP)

(73) Assignee: BROTHER KOGYO KABUSHIKI KAISHA, Nagoya-shi (JP)

(21) Appl. No.: 13/781,629

(22) Filed: Feb. 28, 2013

(30) Foreign Application Priority Data
Feb. 29, 2012 (JP) 2012-042981

(51) Int. Cl. B41J 2/165

(52) U.S. Cl. CPC B41J 2/165
USPC 239/124

(57) ABSTRACT

An inflow opening of an inflow path opens to a space in a tank. An outflow opening of an outflow path opens to the space in the tank. The inflow opening and the outflow opening are vertically above a maximum level of the moisturizing liquid allowed to be stored in the tank.

### CROSS REFERENCE TO RELATED APPLICATION

The present application claims priority from Japanese Patent Application No 2012-042981, which was filed on Feb. 29, 2012, the disclosure of which is incorporated herein by reference in its entirety.

### BACKGROUND OF THE INVENTION

1. Field of the Invention

The present invention relates to a liquid ejection apparatus capable of ejecting liquid such as ink.

2. Description of Related Art

In connection with liquid ejection apparatuses, a technology of moisturizing an ejection space opposing an ejection surface of a head while isolating the ejection space from its surrounding space by a capping mechanism has been known. For example, a known technology is arranged such that air in the ejection space is supplied to a tank, moisturization is conducted while generating bubbles in the tank, and then the moisturized air is sent back to the ejection space.

### SUMMARY OF THE INVENTION

However, according to the technology above, because the moisturization is carried out while bubbles are generated in the tank, splash droplets of the moisturizing liquid are generated along with the bubbles in the tank, and the droplets may enter an outflow path. The droplets. having entered the ejection space through the outflow path adhere to the ejection surface and hence the viscosity of the liquid in an ejection opening is decreased and the meniscus of the liquid formed in the ejection opening may be broken.

An object of the present invention is to provide a liquid ejection apparatus in which the generation of bubbles and splash droplets of moisturizing liquid in a tank are restrained.

According to a first aspect of the present invention, there is provided a liquid ejection apparatus comprising a head, a tank, an inflow path, an outflow path, and a ventilator. The head comprises an ejection surface in which a plurality of ejection openings for ejecting liquid are formed. The tank is configured to store moisturizing liquid. The inflow path connects a space in the tank with an ejection space opposing the ejection surface, and is configured to allow air flow from the ejection space towards the tank passing through the inflow path. An inflow opening of the inflow path opens to the space in the tank. The outflow path connects the space in the tank with the ejection space, and is configured to allow air flow from the tank towards the ejection space passing through the outflow path. An outflow opening of the outflow path opens to the space in the tank. The ventilator is configured to move the air in'the inflow path to the space in the tank and to move the air in the outflow path to the ejection space. The inflow opening and the outflow opening are vertically above a maximum level of the moisturizing liquid allowed to be stored in the tank.

According to a second aspect of the present invention, there is provided a liquid ejection apparatus comprising a head, a tank, an inflow path, an outflow path, and a ventilator. The head comprises an ejection surface in which a plurality of ejection openings for ejecting liquid are formed. The tank is configured to store moisturizing liquid. The inflow path connects a space in the tank with an ejection space opposing the ejection surface, and is configured to allow air flow from the ejection space towards the tank passing through the inflow path. An inflow opening of the inflow path opens to the space in the tank. The outflow path connects the space in the tank with the ejection space, and is configured to allow air flow from the tank towards the ejection space passing through the outflow path. An outflow opening of the outflow path opens to the space in the tank. The ventilator is configured to move the air in the inflow path to the space in the tank and to move the air in the outflow path to the ejection space: The inflow opening and the outflow opening are disposed at an upper half portion of the tank.

According to a third aspect of the present invention, there is provided a liquid ejection apparatus comprising a head, a tank, an inflow path, an outflow path, a ventilator, a level sensor, a supplying device, and a controller. The head comprises an ejection surface in which a plurality of ejection openings for ejecting liquid are formed. The tank is configured to store moisturizing liquid. The inflow path connects a space in the tank with an ejection space opposing the ejection surface, and is configured to allow air flow from the ejection space towards the tank passing through the inflow path. An inflow opening of the inflow path opens to the space in the tank. The outflow path connects the space in the tank with the ejection space, and is configured to allow air flow from the tank towards the ejection space passing through the outflow path. An outflow opening of the outflow path opens to the space in the tank. The ventilator is configured to move the air in the inflow path to the space in the tank and to move the air in the outflow path to the ejection space. The level sensor is configured to detect a level of moisturizing liquid stored in the tank. The supplying device connects the tank and is configured to supply the tank with the moisturizing liquid. The controller is configured to control the supplying device to supply the tank with the moisturizing liquid based on the detection result of the level sensor such that the inflow opening and the outflow opening are vertically above a level of the moisturizing liquid stored in the tank.

According to a fourth aspect of the present invention, there is provided a liquid ejection apparatus comprising a head, a tank, an inflow path, an outflow path, and a ventilator. The head comprises an ejection surface in which a plurality of ejection openings for ejecting liquid are formed. The tank is configured to store Moisturizing liquid and to discharge moisturizing liquid through a discharge opening disposed at a side surface of the tank. The inflow path connects a space in the tank with an ejection space opposing the ejection surface, and is configured to allow air flow from the ejection space towards the tank passing through the inflow path. An inflow opening of the inflow path opens to the space in the tank. The outflow path connects the space in the tank with the ejection space, and is configured to allow air flow from the tank towards the ejection space passing through the outflow path. An outflow opening of the outflow path opens to the space in the tank. The ventilator is configured to move the air in the inflow path to the space in the tank and to move the air in the outflow path to the ejection space. The inflow opening and the outflow opening are vertically above the discharge opening.

### BRIEF DESCRIPTION OF THE DRAWINGS

Other and further objects, features and advantages of the invention will appear more fully from the following description taken in connection with the accompanying drawings in which:

FIG. 1 is an oblique perspective of the appearance of an inkjet printer of First. Embodiment of the present invention.

FIG. 2 is a schematic profile showing the internal structure of the printer.

FIG. 3A is an elevation view of a locking mechanism, showing the state in which the movement of an upper housing is restricted by the locking mechanism.

FIG. 3B is an elevation view of the locking mechanism, showing that the restriction of the movement of the upper housing by the locking mechanism has been released.

FIG. 4 is a plan view of a passage unit and an actuator unit of a head.

FIG. 5 is an enlarged view of the region V enclosed by the dashed line in FIG. 4.

FIG. 6 is a partial cross section taken along the V1-V1 line in FIG. 5.

FIG. 7A and FIG. 7B illustrate the operations of a capping mechanism and a supporting mechanism.

FIG. 8A illustrates purging.

FIG. 8B and FIG. 8C illustrate wiping.

FIG. 9 illustrates a moisturization operation.

FIG. 10A is an oblique perspective of a tank in a moisturizing unit.

FIG. 10B is a schematic profile of the tank.

FIG. 11 is a block diagram of the electric configuration of the printer.

FIG. 12 is a schematic profile of a tank in a moisturizing unit of an inkjet printer according to Second Embodiment of the present invention.

FIG. 13 illustrates a moisturization operation of an inkjet printer according to a modification of First Embodiment of the present invention.

FIG. 14 illustrates a moisturization operation, of an inkjet printer according to Third Embodiment of the present invention.

### DESCRIPTION OF THE PREFERRED EMBODIMENTS

The following will describe a preferred embodiment of the present invention with reference to figures.

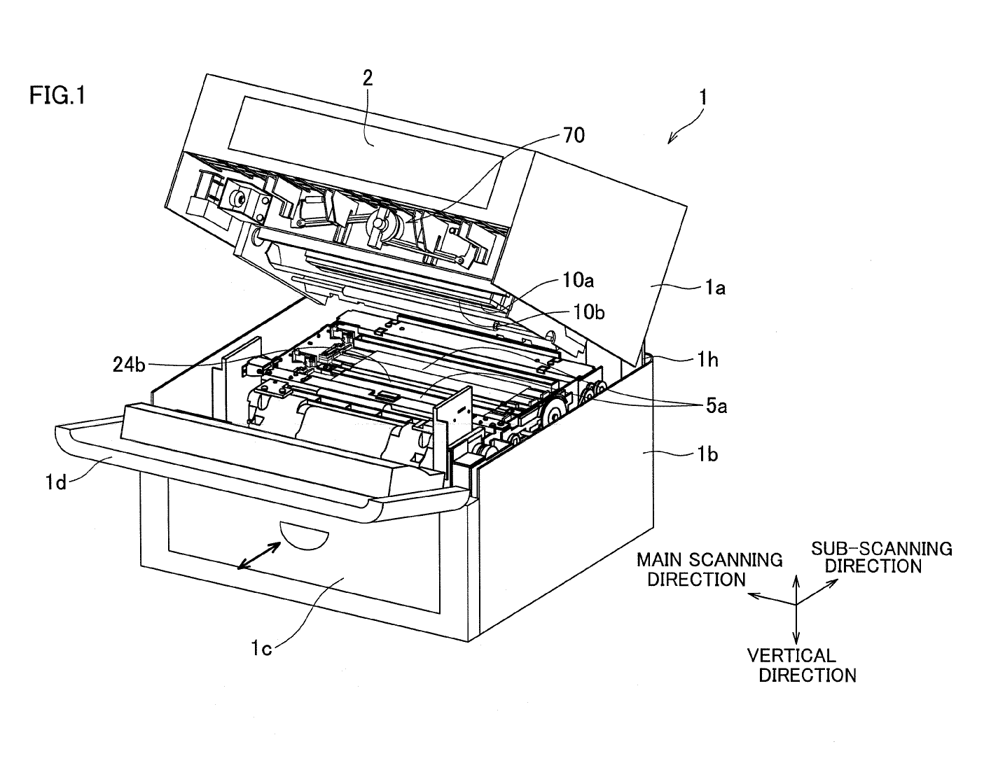

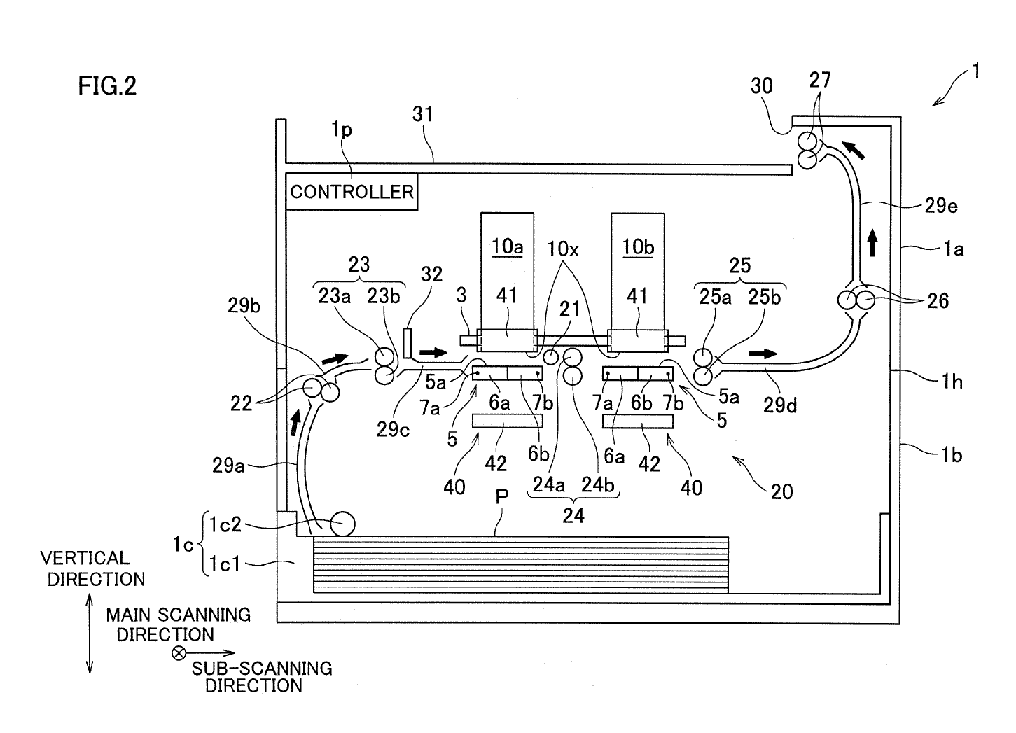

To begin with, referring to FIG. 1 and FIG. 2, the overall structure of an inkjet printer 1 of First Embodiment of the present invention will be described.

The printer 1 includes an upper housing 1a and a lower housing 1b which are both rectangular parallelepiped and are substantially identical in size. The upper housing 1a is an open-bottom box whereas the lower housing 1b is an open-top box. As the upper housing 1a is put on the lower housing 1b so that each closes the opening of the other, the space inside the printer 1 is defined (see FIG. 2).

On the top plate of the upper housing 1 a is provided a sheet discharge section 31. In the space defined by the housings 1a and 1b, a conveying path on which sheets P are conveyed is formed from a sheet supply unit 1c toward a sheet discharge section 31, along the thick arrows shown in FIG. 2.

The upper housing 1a is arranged to be rotatable with respect to the lower housing lb about a hinge 1h which is a lower side of the upper housing 1a. On account of the rotation, the upper housing 1a selectively takes a close position (FIG. 2) where the upper housing 1a is close to the lower housing 1b or a separated position (FIG. 1) where the upper housing 1a is separated from the lower housing 1b as compared to the close position. The upper housing 1a is regulated by a stopper or the like so as not to open more than a predetermined angle (e.g., 29 degrees) with respect to the horizontal plane. When the upper housing 1a is at the separated position, a part of the conveying path is exposed and a working space for the user is formed between the upper housing 1a and the lower housing 1b. This working space allows the user to manually clean heads 10a and 10b, remove a sheet P jammed at the conveying path, and so on.

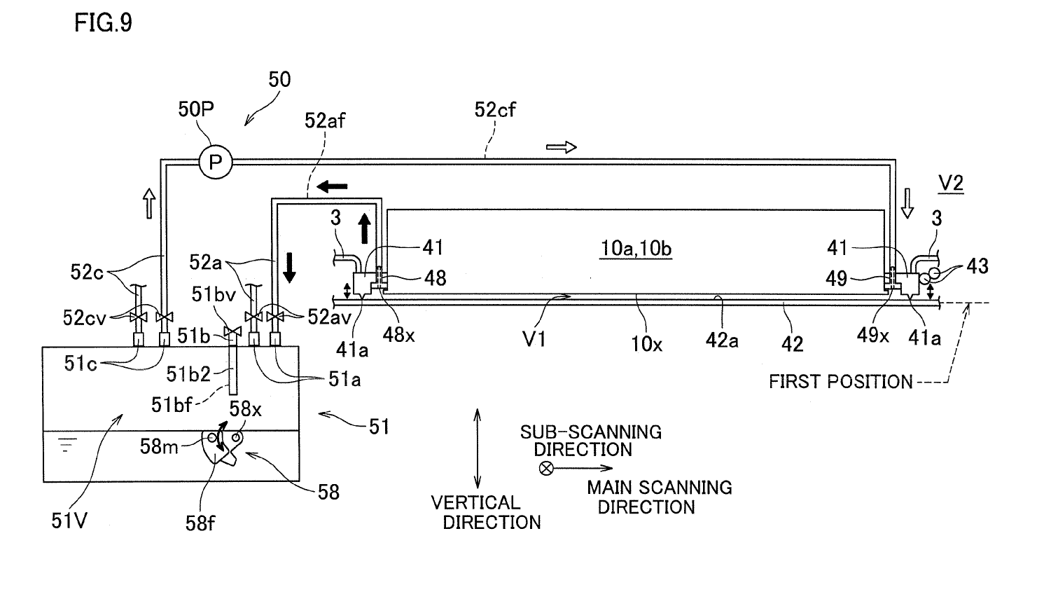

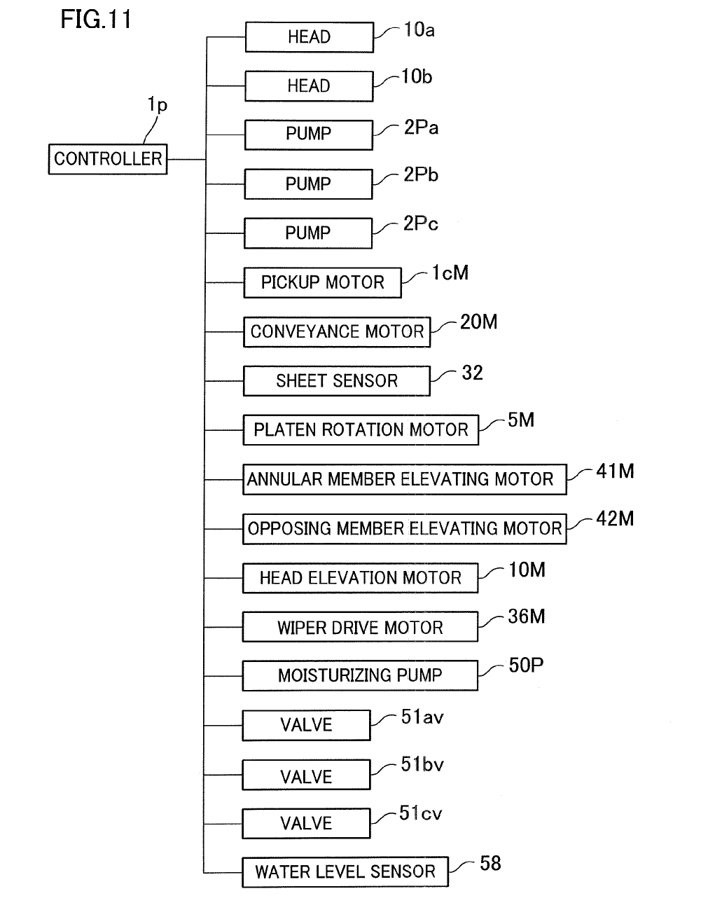

On the front surface of the upper housing 1a (i.e., the face on the left side in FIG. 1) are provided a cartridge 2 and a locking mechanism 70. The cartridge 2 includes a preprocessing liquid container containing preprocessing liquid, an ink container containing black ink, a moisturizing liquid container containing moisturizing liquid, and a housing which houses these three containers. The preprocessing liquid has a function of preventing ink from spreading on or penetrating a sheet, a function of improving the coloring and quick dry properties of the ink, or the like, by coagulating pigment in the ink. The preprocessing liquid may include polyvalent metal salt such as cationic polymer and magnesium salt. The moisturizing liquid may be water to which pure water, preservative or the like is added. The preprocessing liquid container, the ink container, and the moisturizing liquid container are connected to a head 10a, a head 10b, and a tank 51 (see FIG. 9) via tubes or the like, respectively. The liquid in each container is suitably supplied to each of the heads 10a and 10b and the tank 51 by the driving of pumps 2Pa, 2Pb, and 2Pc (see FIG. 11) under the control of the controller 1p. The locking mechanism 70 restricts the movement of the upper housing 1a when the upper housing 1a is at the close position. On the front surface of the lower housing 1b is provided a lid 1d which is openable and able to cover the front surface of the upper housing 1a. As the lid 1d is opened, the locking mechanism 70 is exposed. The details of the locking mechanism 70 will be given later.

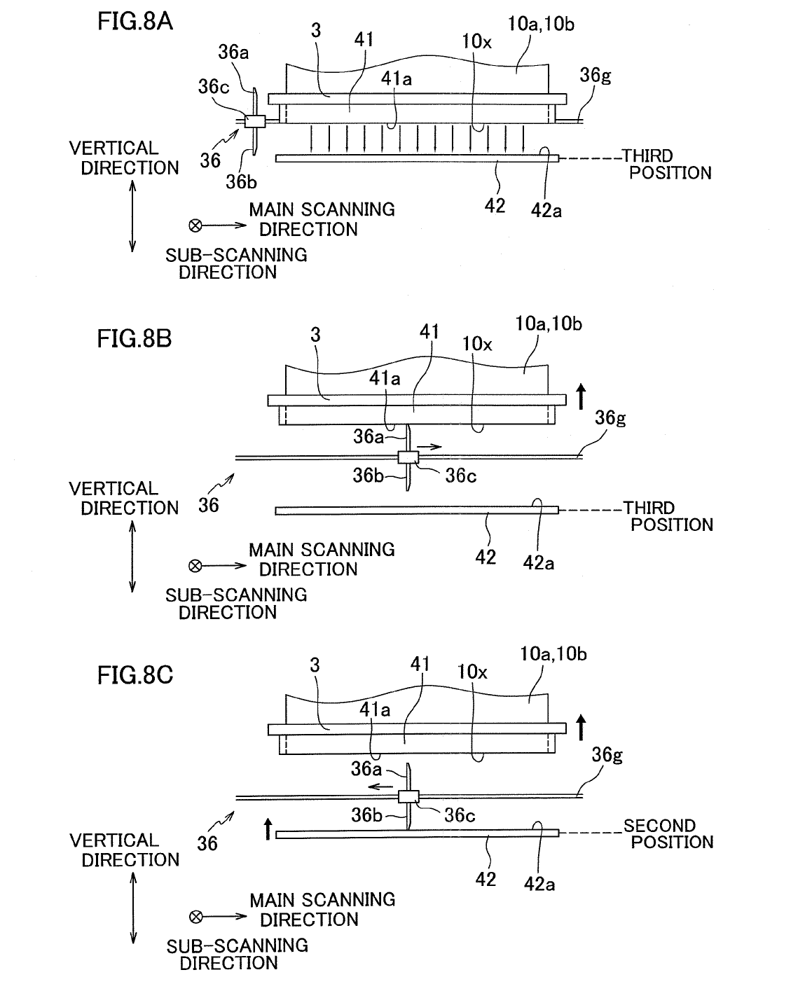

The upper housing 1a supports members such as the heads 10a and 10b, a controller 1p, and a part of the conveying unit 20 (see FIG. 2). The lower housing 1b supports members such as opposing members 42, the remaining part of the conveying unit 20, a sheet supply unit 1c, wiper units 36 (see FIG. 8A to FIG. 8C) provided for the respective heads 10a and 10b, and a tank 51 (see FIG. 9) of the moisturizing unit 50.

The heads 10a and 10h are identical with each other in structure and are line-type heads each being substantially rectangular parallelepiped and long in the main scanning direction (i.e., in the direction orthogonal to FIG. 2). For recording (image formation), preprocessing liquid and black ink (which may be referred to generally as liquid) are ejected from the lower surface (ejection surface 10x) of each of the heads 10a and 10b. The heads 10a and 10b are disposed at predetermined intervals in the sub-scanning direction (which is orthogonal to the main scanning direction and the vertical direction), and are supported by the upper housing 1a via a holder 3. The holder 3 also supports an annular member 41 which is provided for each of the heads 10a and 10b. The annular member 41 encloses the ejection surface 10x in plan view.

The opposing members 42 are disposed vertically below the respective heads 10a and 10b. The opposing member 42 is a rectangular plate which is a size larger than the annular member 41 and made of a material which does not absorb or hardly absorbs moisture, such as glass and metal (e.g., SUS). The annular member 41 and the opposing member 42 constitute a capping mechanism 40. The details of the capping mechanism 40 will be given later.

The conveying unit 20 includes supporting mechanisms 5, roller pairs 22, 23, 24, 25, 26, and 27, guides 29a, 29b, 29c, 29d, and 29e, and an intermediate roller 21.

Among the members of the conveying unit 20, the intermediate roller 21, the upper roller 24a of the roller pair 24, the roller pairs 26 and 27, and the guides 29d and 29e are supported by the upper housing 1a. The supporting mechanisms 5, the roller pairs 22, 23, and 25, the lower roller 24b of the roller pair 24, and the guides 29a, 29b, and 29c are supported by the lower housing 1b.

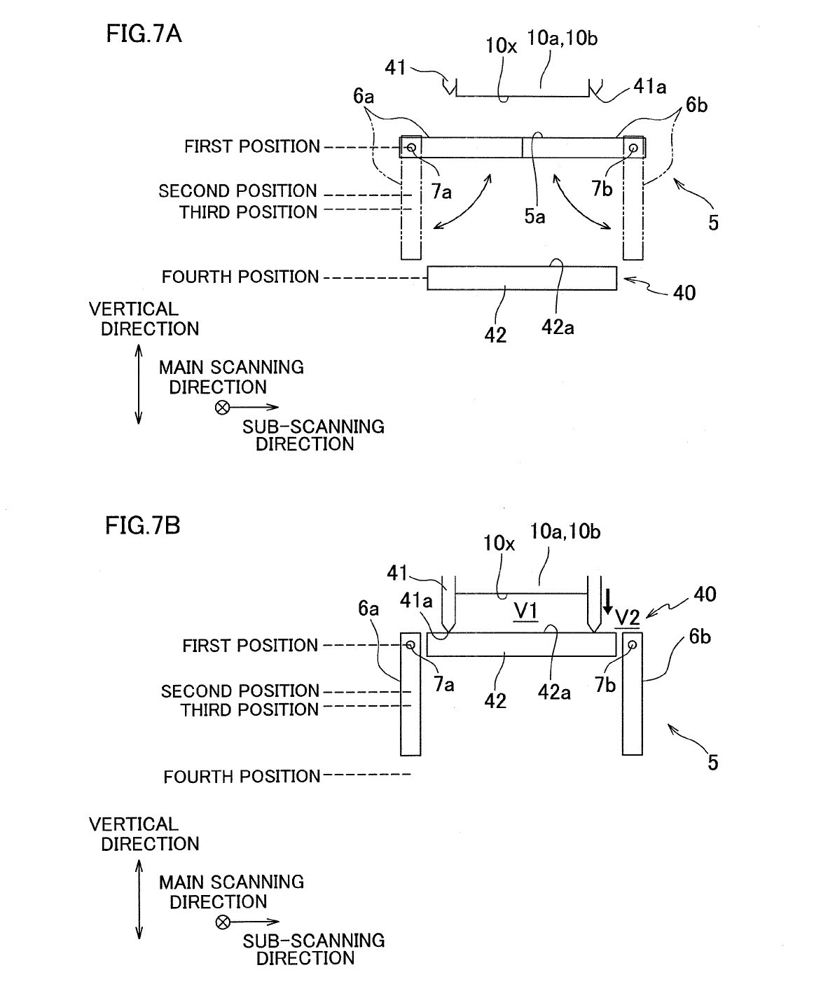

The supporting mechanisms 5 are disposed vertically below the heads 10a and 10b, respectively. Each supporting mechanism 5 is constituted by two platens 6a and 6b. The platens 6a and 6b are arranged to be rotatable about the shafts 7a and 7b. Under the control of the controller 1p, the platens 6a and 6b are rotated by a platen rotation motor 5M (see FIG. 11), and selectively take a supporting surface forming position (FIG. 1) or an open position (FIG. 7B). At the supporting surface forming position, the leading ends of the platens 6a and 6b contact each other and these platens 6a and 6b form the supporting surface 5a which supports a sheet P while opposing the ejection surface 10x. The supporting surface 5a is basically flat in shape. At the open position the platens 6a and 6b hang down. The platens 6a and 6b are at the supporting surface forming position at the time of recording, and are at the open position at the time of maintenance.

The maintenance is operations to restore or maintain the state of the liquid in an ejection opening 14a, including capping, wiping, a liquid discharge operation (including flushing and purging), a moisturization operation, or the like. These operations are executed when, for example, a user instructs to perform it while the controller 1p does not receive a recording command. The details of the operations will be given later.

The roller pairs 22 to 27 are disposed in this order from the upstream in the conveyance direction to form a conveying path connecting the sheet supply unit 1c with the sheet discharge section 31. The lower rollers 23b, 24b, and 25b of the roller pairs 23 to 25 and one rollers of the roller pairs 26 and 27 are connected to a conveyance motor 20M (see FIG. 11). These rollers are drive rollers which are rotated by the conveyance motor 20M under the control of the controller 1p. The upper rollers 23a, 24a, and 25a of the roller pair 23 to 25 and the other rollers of the roller pairs 26 and 27 are driven rollers.

The guides 29a to 29e are disposed in this order between the sheet supply unit 1c and the roller pair 22 and between the roller pairs from the upstream in the conveyance direction, so as to form the conveying path. Each of the guides 29a to 29e is constituted by a pair of plates which are distanced from each other.

The intermediate roller 21 is disposed between the head 10a and the roller pair 24 and vertically above the conveying path.

The sheet supply unit 1c includes a sheet feeding tray 101 and a pickup roller 1c2. The sheet feeding tray 1e1 is detachable to the lower housing 1b in the sub-scanning direction. The sheet feeding tray 1c1 is an open-top box capable of storing sheets P with different sizes. Under the control of the controller 1p, the pickup roller 1e2 is rotated by a pickup motor 1cM (see FIG. 11) to send out the vertically topmost sheet P in the sheet feeding tray 1e1.

The controller 1p includes, in addition to a CPU (Central Processing Unit) which is a processing unit, members such as a ROM (Read Only Memory), a RAM (Random Access Memory: including non-volatile RAM), an ASIC (Application Specific Integrated Circuit), an I/F (Interface), an I/O (Input/Output Port), and an internal timer for measuring time. The ROM stores a program executed by the CPU, various fixed data, or the like. The RAM temporarily stores data (such as image data) required for the execution of a program. The ASIC executes the rewriting, sorting or the like (e.g., signal processing and image processing) of image data. The I/F exchanges data with an external apparatus. The I/O deals with input/output of detection signals of various sensors. Alternatively, no ASIC may be provided and the rewriting, sorting or the like of image data may be performed by a program executed by the CPU or the like.

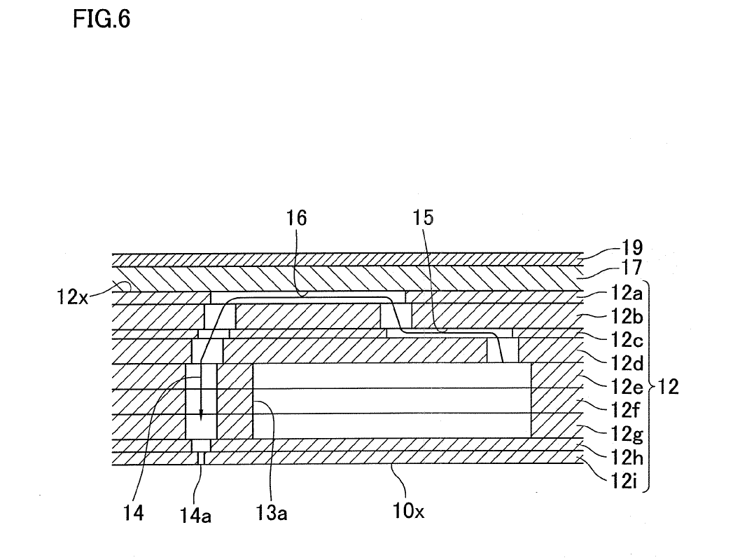

Based on a recording command supplied from an external apparatus (e.g., a PC connected to the printer 1), the controller 1p controls the preparation operation concerning recording, the supply/conveyance/discharge operation of a sheet P, a liquid ejection operation in sync with the conveyance of a sheet P, or the like, in order to form an image on the sheet P. A sheet P sent out from the sheet supply unit 1c passes through the spaces between the guides 29a to 29e and is conveyed in the conveyance direction, while being sandwiched between the roller pairs 22 to 27. Each time a sheet P passes through the position immediately below each of the heads 10a and 10b while being supported by the supporting surface 5a, each of the heads 10a and 10b is driven under the control of the controller 1p and liquid is ejected from an ejection opening 14a (see FIG. 6) of each ejection surface 10x to the surface of the sheet P, with the result that an image is formed on the sheet P. The operation to eject the liquid from the ejection opening 14a is performed based on a detection signal supplied from a sheet sensor 32 which detects the leading end of a sheet P. The sheet P is then conveyed upward and is discharged to the sheet discharge section 31 through an opening 30 which, is formed at an upper part of the upper housing 1a.

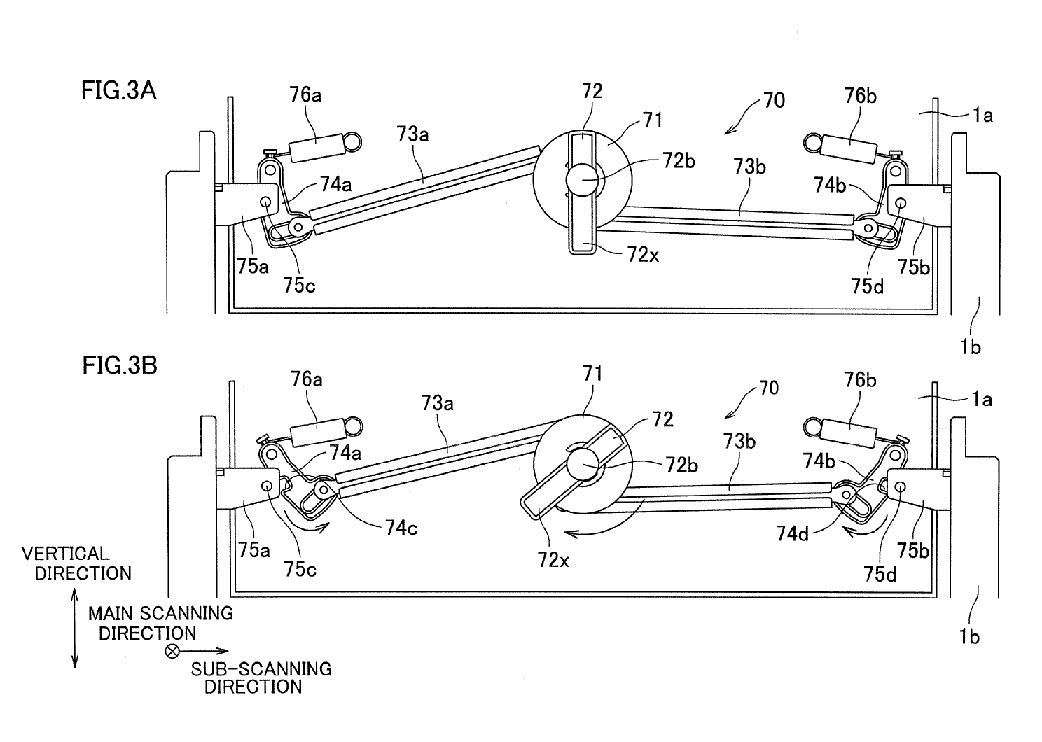

Now, referring to FIG. 3A and FIG. 3B, the details of the locking mechanism. 70 will be given.

The locking mechanism 70 includes a cylindrical rotating member 71, two interlocking members 73a and 73b, two swing members 74a and 74b, two springs 76a and 76b, and two fixing members 75a and 75b. An end of each of the interlocking members 73a and 73b in the longitudinal direction is connected to the peripheral surface of the rotating member 71. The swing members 74a and 74b have concave portions 74c and 74d which are open in the directions away from the rotating member 71a, respectively. The fixing members 75a and 75b respectively have shaft members 75c and 75d which are capable of being inserted into the concave portions 74c and 74d, respectively. The swing shafts of the swing members 74a and 74b are fixed to the upper housing 1a. The springs 76a and 76b are fixed to the upper housing 1a at ends which are close to the rotating member 71a. The fixing members 75a and 75b are fixed to the lower housing 1b.

On the front surface of the rotating member 71 is fixed a stick-shaped knob 72. The knob 72 rotates together with the rotating member 71. The springs 76a and 76b bias the upper ends of the swing members 74a and 74b toward the rotating member 71. With the arrangement above, when no external force is applied, the members of the locking mechanism 70 are, as shown in FIG. 3A, in a static state while the knob .72 extends in the vertical direction. In this state, the concave portions 74c and 74d are engaged with the shaft members 75c and 75d, respectively, Because of this engagement, the movement of the upper housing 1a is restricted so that the upper housing 1a at the close position do not rotate toward the separated position. As the user rotates the knob 72 clockwise against the biasing forces of the springs 76a and 76b, as shown in FIG. 3B, the concave portions 74c and 74d are disengaged from the shaft members 75c and 75d. With this, the restriction of the movement of the upper housing 1a is released. As the upper housing 1a is returned from the separated position to the close position, the concave portions 74c and 74d are engaged with the shaft members 75c and 75d again. With this, the movement of the upper housing 1a is restricted by the locking mechanism 70 again.

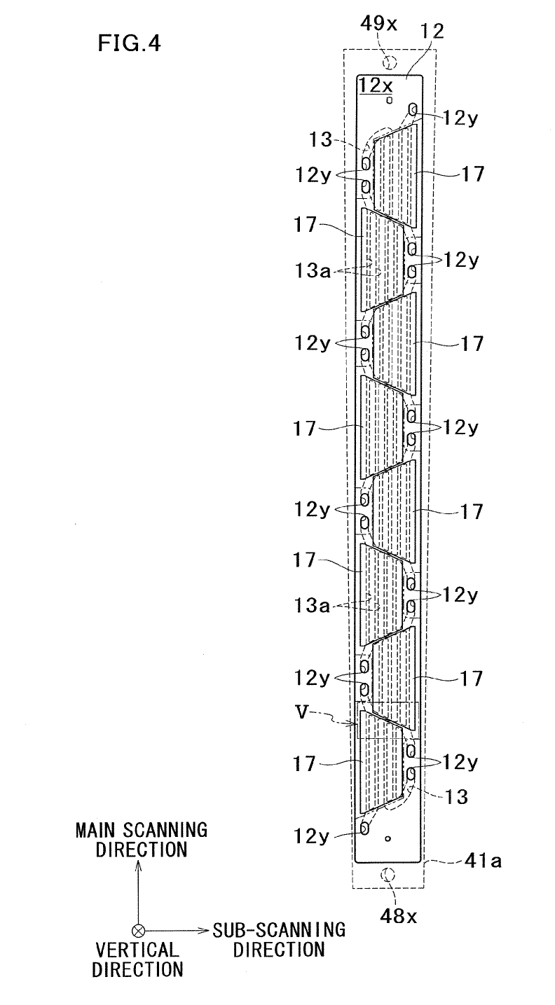

Now, referring to FIG. 4 to FIG. 6, the arrangement of the heads 10a and 10b will be detailed.

Each of the heads 10a and 10b includes members such as a reservoir unit and a passage unit 12 which are vertically piled up, eight actuator units 17 fixed to the upper surface 12x of the passage unit 12, and an FPC (flat flexible circuit board) 19 connected to each actuator unit 17. In the reservoir unit, a passage including a reservoir which temporarily stores liquid supplied from the corresponding container of the cartridge 2 is formed. In the passage unit 12, a passage from the opening 12y of the upper surface 12x to each ejection opening 14a of the lower surface (ejection surface 10x) is formed. The actuator unit 17 includes a piezoelectric actuator for each ejection opening 14a.

The lower surface of the reservoir unit has concaves and protrusions. Each of the protrusions is adhered to a region (enclosed by a two-dot chain line and including an opening 12y shown in FIG. 4) which is on the upper surface 12x of the passage unit 12 and where no actuator unit 17 is disposed. The leading end surface of the protrusion has an opening which is connected to the reservoir and opposes each opening 12y of the passage unit 12. With this, the reservoir is connected to individual passages 14 via each opening above. The concave portion opposes the upper surface 12x of the passage unit 12, the surface of the actuator unit 17, and the surface of the FPC 19, with a slight gap being formed therebetween.

The passage unit 12 is a laminated body formed by laminating nine rectangular metal plates 12a, 12b, 12c, 12d, 12e, 12f, 12g, 12h, and 12i which are substantially identical in size and by adhering the plates with one another (see FIG. 6). The passage in the passage unit 12 includes a manifold passage 13 having an opening 12y at one end, a sub-manifold passage 13a branching from the manifold passage 13, and an individual passage 14 which connects the outlet of the sub-manifold passage 13a with the ejection opening 14a via the pressure chamber 16. The individual passage 14 is formed for each ejection opening 14a and includes an aperture 15 which is an aperture for adjusting the flow resistance. At the region on the upper surface 12x to which region each actuator unit 17 is adhered, substantially diamond-shaped openings are formed in a matrix manner to expose the pressure chambers 16. At a region on the lower surface (ejection surface 10x) which region opposes the region to which each actuator unit 17 is adhered, ejection openings 14a are formed in a matrix manner and in the same arrangement as the pressure chambers 16.

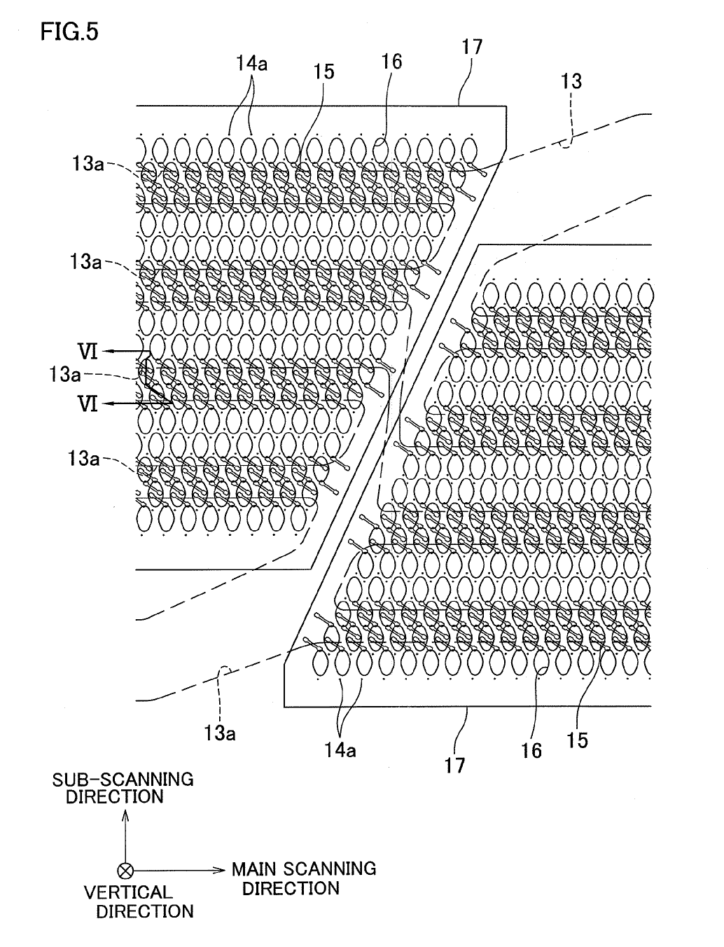

In connection with the above, in FIG. 5, the pressure chambers 16 and the apertures 15 are depicted by full lines even if they are underneath the actuator unit 17.

The actuator units 17 are each trapezoidal in plan view and are staggered on the upper surface 12x of the passage unit 12 to form two lines. Each actuator unit 17 covers a plurality of openings of the pressure chambers 16, which are formed in the region where the actuator unit 17 is adhered. Although not illustrated, the actuator unit 17 is constituted by a piezoelectric layer, a diaphragm, a common electrode, and individual electrodes. Among these members, the piezoelectric layer, the diaphragm, and the common electrode are all trapezoidal and sized to define the outer shape of the actuator unit 17. The individual electrodes are provided for the respective pressure chambers 16 and are disposed on the upper surface of the piezoelectric layer to oppose the respective pressure chambers 16. The diaphragm is disposed between the common electrode and the passage unit 12. A part of the actuator unit 17 which part corresponds to each individual electrode functions as a piezoelectric actuator. Each actuator is independently deformable in response to the application of a voltage via the FPC 19. The actuator changes the capacity of the corresponding pressure chamber 16 to provide an energy to the liquid in the pressure chamber 16. With this, the liquid is ejected through the ejection opening 14a.

The FPC 19 is provided with a driver IC and wires which correspond to the respective electrodes of the actuator unit 17. The FPC 19 is fixed to the actuator unit 17 at one end and fixed to the control substrate of the head 10a or 10b at the other end. The control substrate adjusts a signal supplied from the controller 1p and inputs the adjusted signal to the driver IC via the wire of the FPC 19. The driver IC converts the signal input from the control substrate to a drive signal and sends the drive signal to each electrode of the actuator unit 17 via the wire of the FPC 19.

Now, referring to FIG. 7A to FIG. 9, the arrangement of the capping mechanism 40, the arrangement of the moisturizing unit 50, the arrangement of the wiper unit 36, the operations in the maintenance, or the like will be described below.

The annular member 41 is connected with a plurality of gears 43 (see FIG. 9), and moves up or down as the gears 43 are rotated by an annular member elevating motor 41M (see FIG. 11) under the control of the controller 1p.

The opposing member 42 is connected to the opposing member elevating motor 42M (see FIG. 11) and moves up or down by the opposing member elevating motor 42M under the control of the controller 1p. The opposing member 42 takes one of a first position, a second position, a third position, and a fourth position (see FIG. 7A and FIG. 7B). The first position is the highest, the second position is the second highest, the third position is the third highest, and the fourth position is the lowest.

The opposing member 42 is at the first position when the capping or flushing is conducted. The opposing member 42 is at the second position When the opposing surface 42a (which is the surface of the opposing member 42 and opposes the ejection surface 10x when the platens 6a and 6b are at the open position) is wiped. The opposing member 42 is at the third position when the wiping or purging of the ejection surface 10x is conducted. The opposing 5, member 42 is at the fourth position when the recording is conducted or the apparatus is on standby. The separation distance between the opposing surface 42a and the ejection surface 10x when the opposing member 42 is at the first position is identical with the separation distance between the supporting surface 5a and the ejection surface 10x at the time of the recording.

The capping mechanism 40 selectively takes a capped state (see FIG. 7B and FIG. 9) or an uncapped state (see (FIG. 2 and FIG. 7A). In the capped state, the ejection space V1 opposing the ejection surface 10x of the corresponding head 10a or 10b is covered, and separated from the space V2 which surrounds the ejection space V1, At the uncapped state, the ejection space V1 opposing the ejection surface 10x of the corresponding head 10a or 10b is not covered, and open to the space V2 surrounding the ejection space V1, The capping is an operation to maintain the capping mechanism 40 to be in the capped state. To change the state of the capping mechanism 40 to the capped state, as shown in FIG. 7B, the controller 1p moves down the annular member 41 while the supporting mechanism 5 is set at the Open position and the opposing member 42 is set at the first position. As a result, the leading end 41a of the annular member 41 contacts the opposing surface 42a and hence the closed ejection space V1 is formed between the opposing surface 42a and the ejection surface 10x. The capping is conducted when; for example, no recording command is received for at least a predetermined time. By the capping, the drying of the ejection space V1 is prevented and the increase in the viscosity of the liquid in the ejection opening 14a is restrained.

The flushing is an operation to discharge liquid through the ejection opening 14a by driving the actuator unit 17 based on flushing data which is different from recording data (image data), The purging is an operation to discharge liquid through the ejection opening 14a by supplying the liquid to the head 10a or 10b by using a pump 2Pa, 2Pb (see FIG. 11) and then applying a pressure to the liquid in the head 10a or lob. The flushing and the purging are conducted when no liquid is ejected through the ejection opening 14a for at least a predetermined time (the predetermined time may be different between the flushing and the purging). By the flushing or the purging, liquid with increased viscosity in the ejection opening 14a and liquid contaminated with foreign matters (dust, bubbles or the like) are discharged and the ejection properties are restored.

When the flushing is conducted, the controller 1p sets the supporting mechanism 5 at the open position and sets the opposing member 42 at the first position, and drives the actuator unit 17 of the head 10a or 10b while the leading end 41a of the annular member 41 is positioned either at the same height as the ejection surface 10x or vertically above the ejection surface 10x. When the purging is conducted, the controller 1p sets the supporting Mechanism 5 at the open position and sets the opposing member 42 at the third position, and drives the pump 2Pa, 2Pb while the leading end 41a of the annular member 41 is either at the same height as the ejection surface 10x or vertically above the ejection surface 10x. The liquid discharged on account of the flushing or the purging is received by the opposing surface 42a.

The wiping is an operation to remove a foreign matter on a target by causing a wiper to contact the target and moving the wiper relative to the target. The wiping is conducted by using a wiper unit 36 (see FIG. 8A to FIG SC). There are two types of the wiping, namely, the wiping of the ejection surface 10x and the wiping of the opposing surface 42a. For example, the wiping of the ejection surface 10x is conducted after the completion of the purging, whereas the wiping of the opposing surface 42a is conducted after the wiping of the ejection surface 10x after the completion of the purging, and also after the completion of the flushing.

The wiper unit 36 includes two wipers 36a and 36b and a base portion 36c supporting the wipers 36a and 36b. The wipers 36a and 36b are both plate-shaped members made of an elastic member (such as rubber), and protrude upward and downward from the upper surface and the lower surface of the base portion 36c, respectively, In the sub-scanning direction, the wiper 36a is slightly longer than the length of the ejection surface 10x and the wiper 36b is slightly longer than the length of the opposing surface 42a. The base portion 36c is connected to a wiper drive motor 36M (see FIG. 11), and is able to be reciprocated in the main scanning direction along the guide hole 36g by the wiper drive motor 36M under the control of the controller 1p. The home position of the base portion 36c is to the left of the heads 10a and 10b in FIG. 8A (i.e., the position where the base portion 36c is provided in FIG. 8A).

When the wiping of the ejection surface 10x is conducted, as shown in FIG. 8B, the controller 1p moves up the heads 10a and lob together with the holder 3 by driving a head elevation motor 10M (see FIG. 11). The controller 1p then positions the, supporting mechanism 5 at the open position and positions the opposing member 42 at the third position, and drives the wiper drive motor 36M while the leading end 41a of the annular member 41 is at the same height as the ejection surface 10x or vertically above the ejection surface 10x. With this, the base portion 36c moves rightward in FIG. 8B from the home position and a part of the wiper 36a around its leading end moves relative to the ejection surface 10x while contacting the ejection surface 10x. As a result, foreign matters on the ejection surface 10x are removed. To conduct the wiping of the opposing surface 42a subsequent to the wiping of the ejection surface 10x, the controller 1p causes the base portion 36c to be on standby at a position to the right Of the heads 10a and 10b in FIG. 8B.

To conduct the wiping of the opposing surface 42a, as shown in FIG. 8C, the controller 1p moves up the heads 10a and 10b together with the holder 3 by driving a head elevation motor 10M (see FIG. 11), so as to position the heads 10a and 10b to be vertically above the position in the wiping of the ejection surface 10x shown in FIG. 8B. The controller 1p then positions the supporting mechanism 5 at the open position and positions the opposing member 42 at the second position, and drives the wiper drive motor 36M while the leading end 41a of the annular member 41 is at the same height as the ejection surface 10x or is vertically above the ejection surface 10x. With this, a part of the wiper 36b around its leading end moves relative to the opposing surface 42a while contacting the opposing surface 42a. As a result, foreign matters on the opposing surface 42a are removed.

To conduct the wiping of the opposing surface 42a subsequent to the wiping of the ejection surface 10x, the controller 1p moves the base portion 36c leftward as shown in FIG. 8C and stops it at the home position. With this movement, the opposing surface 42a is wiped. On the other hand, in cases other than the above, the controller 1p moves the base portion 36c rightward from the home position in FIG. 8C and stops it at a position to the right of the heads 10a and 10b. With this movement, the opposing surface 42a is wiped. After moving the opposing member 42 to the fourth position, the controller 1p moves the base portion 36c leftward in FIG. 8C and stops it at the home position.

The moisturization operation is an operation to moisturize the ejection space. V1 by driving a moisturizing pump 50P (see FIG. 9) of the moisturizing unit 50 while keeping the capping mechanism 40 to take the capped state. The moisturization operation is, for example, periodically conducted while the capping is maintained. By the moisturization operation, moisturized air is supplied into the ejection space V1 and hence the increase in the viscosity of the liquid in the ejection opening 14a is restrained.

The moisturizing unit 50 includes a tank 51 which stores moisturizing liquid, two tubes 52a, two tubes 52c, and a moisturizing pump 50P. Each of the two tubes 52a connects the tank 51 with a joint 48 of the head 10a or 10b, and has an inflow path 52a1 therein. The inflow path 52af connects a space 51V in the tank 51 with the ejection space V1 when the capping mechanism 40 is in the capped state, and air flowing out from the ejection space V1 towards the tank 51 passes through the inflow path 52af. Each of the two tubes 52c connects the tank 51 with a joint 49 of the head 10a or 10b and has an outflow path 52cf therein. The outflow path 52cf connects the space 51V with the ejection space V1 when the capping mechanism 40 is in the capped state, and air flowing out from the tank 51 towards the ejection space V1 passes through the outflow path 52cf The two joints 48 and 49 are provided for, each of the heads 10a and 10b, and are disposed at One end and the other end of each of the heads 10a and 10b in the main scanning direction. The joints 48 and 49 are attached to the annular member 41, Each of the joints 48 and 49 is substantially cylindrical and connects the ejection space V1 with the space surrounding the ejection space V1 by the internal space of the same. The moisturizing pump 50P is disposed on a non-edge part of each tube 52c.

On the upper surface of the tank 51 is provided protruding portions 51a, 51b, and 51c which are cylindrical in shape and protrude upward. At the leading ends of the two protruding portions 51a, the tubes 52a are attached, respectively. At the leading ends of the two protruding portions 51c, the tubes 52c are attached, respectively. The proximal ends of the protruding portions 51a and 51c are open to the space 51V via through holes made through the upper wall of the tank 51. The protruding portion 51b is connected to a cylindrical member 51b2 which protrudes downward in the tank 51. The internal spaces of the protruding portion 51b and the cylindrical member 51b2 are connected with each other via a through hole made through the upper wall of the tank 51, so as to form an atmosphere connection path 51bf which connects the space 51V with the atmosphere.

Around the protruding portion 51a of each tube 52a is provided a valve 52av which opens or closes the inflow path 52af. Around the protruding portion 51e of each tube 52c is provided a valve 52cv which opens or closes the outflow path 52cf. Around the upper end of the protruding portion 51b is provided a valve 51bv which opens or closes the atmosphere connection path 51bf. These valves 51bv, 52av, and 52ev are opened or closed under the control of the controller 1p.

To conduct the moisturization operation, the controller 1p sets the capping mechanism 40 in the capped state and drives the moisturizing pump 50P while keeping the valves 51bv, 52av, and 52cv to be open. As s result, the air in the ejection space V1 is collected through an opening 48x on the lower surface of the joint 48, passes through the inflow path 52af in the tube 52a, and eventually flows into the space 51V. The air having flown into the space 51V is moisturized by (the natural evaporation of) the moisturizing liquid stored in the space 51V, and then passes through the outflow path 52cf in the tube 52c and reaches the ejection space V1 via an opening 49x on the lower surface of the joint 49. In FIG. 9, black arrows indicate the flow of air before the moisturization, whereas outline arrows indicate the flow of air after the moisturization.

In addition to the above, the controller 1p closes the valves 51bv, 52av, and 52ev when the capping mechanism 40 is in the uncapped state, and opens the valve 51bv, 52av, and 52cv when the capping mechanism 40 is in the capped state and the moisturizing pump 50P is not driven. Furthermore, the controller 1p is able to control the moisturizing pump 50P such that the airflow produced by the moisturizing pump 50P is reversed to cause'the air flowing out from the ejection space V1 towards the tank 51 to pass through the outflow path 52cf and to cause the air flowing out from the tank 51 towards the ejection space V1 to pass through the inflow path 52af.

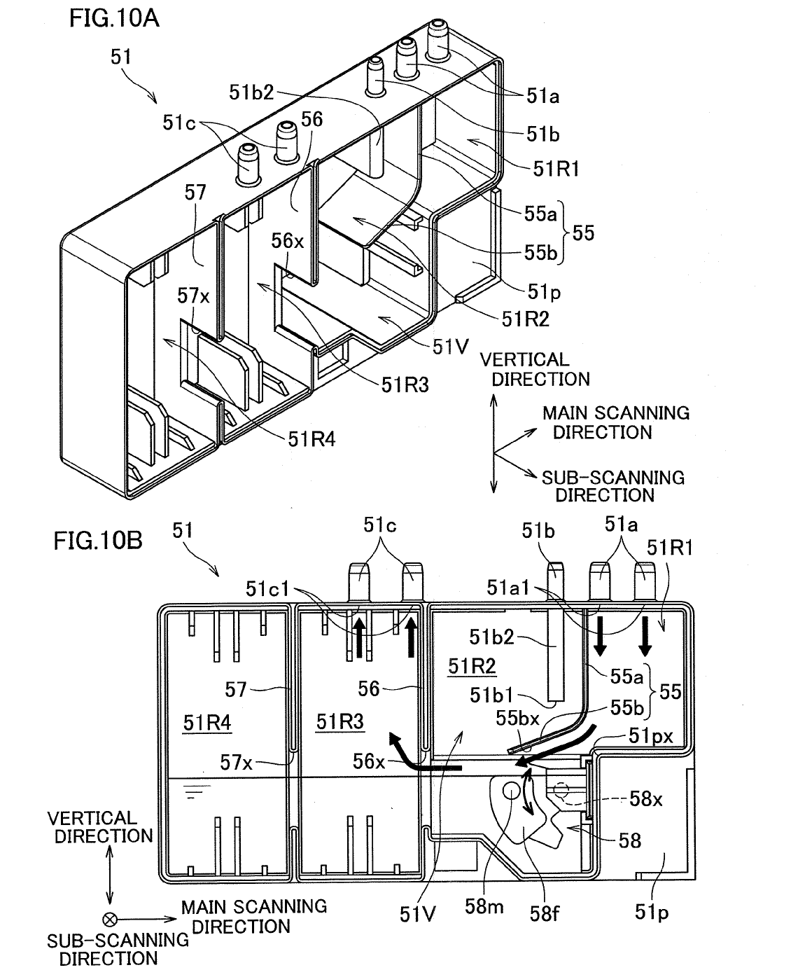

The tank 51 is provided with a water level sensor 58 which detects the water level of moisturizing liquid. The water level sensor 58 includes a float 58f and a magnetic sensor (not illustrated) which detects the existence of a magnet 58m fixed to the float 58f. The float 58f is swingable about a shaft 58x fixed to a side wall of the tank 51. As air is enclosed therein, the float 58f swings to follow the movement of the surface of the moisturizing liquid. The magnetic sensor detects whether the position of the magnet 58m is at the position indicating the maximum water level of the tank 51. Before conducting the moisturization operation, based on a detection signal from the water level sensor 58, the controller 1p drives a pump 2Pc (see FIG. 11) to supply the moisturizing liquid from the moisturizing liquid container of the cartridge 2 to the space 51V so that the water level of the moisturizing liquid stored in the space 51V is at the maximum (as shown in FIG. 10B), when the moisturizing liquid stored in the space 51V is not at the maximum water level.

Now, referring to FIG, 10A and FIG. 10B, the arrangement of the tank 51 and the airflow in the space 51V will be detailed. In FIG. 10A and FIG. 10B, one side wall of the tank 51 is not shown for easy explanation of the arrangement inside the tank 51.

The tank 51 is a housing which is substantially: rectangular parallelepiped in shape. The space 51V is divided into four chambers 51R1, 51R2, 51R3, and 51R4 by a flow adjuster 55 and partitions 56 and 57. The flow adjuster 55 separates the chamber 51R1 from the chamber 51R2, the partition 56 separates the chamber 51R2 from the chamber 51R3, and the partition 57 separates the chamber 51R3 from the chamber 51R4. An opening (inflow opening) 51a1 at the proximal end of the protruding portion 51a is disposed in the chamber 51R1, an opening (atmosphere opening) 51b1 at the lower end of the cylindrical member 51b2 is disposed in the chamber 51R2, and an opening (outflow opening) 51c1 at the proximal end of the protruding portion 51e is disposed in the chamber 51R3. The chambers 51R1 to 51R4 are lined up in the main scanning direction in this order. Because the protrusion 51p vertically below the chamber 51R1 is substantially identical in size with the chamber 51R1, the chamber 51R1 is smaller than the other chambers 51R2 to 51R4 and is about identical in size with the upper half of the chamber 51R3. The moisturizing liquid is stored in lower parts of the chambers 51R2 to 51R4. The inflow opening 51a1 and the, outflow opening 51c1 are disposed vertically above the maximum water level (shown in FIG. 10B) of the moisturizing liquid.

The flow adjuster 55 is a bended plate and includes a vertical part 55a and an inclined part 55b. The upper end of the vertical part 55a is fixed to the upper wall of the tank 51 and is between two protruding portions 51a and one protruding portion 51b. The vertical part 55a protrudes vertically downward from the upper wall of the tank 51 in the same manner as the cylindrical member 51b2 and is substantially identical in length with the cylindrical member 51b2. The inclined part 55b extends, from the lower end of the vertical part 55a, in a direction inclined from the vertical direction (i.e., leftward and downward in FIG. 10B), which is formed by a direction component running from the inflow opening 51a1 toward the outflow opening 51c1 (i.e. leftward in FIG. 10B) and a direction component running vertically downward. The inclined part 55b covers the atmosphere opening 51b1 from below. The flow adjuster 55 has, at its lower end, a slope 55bx (lower surface of the inclined part 55b) which is inclined in a direction formed by a direction component running from the inflow opening 51a1 toward the outflow opening 51c1 (leftward in FIG. 10B) and a direction component running vertically downward. The flow adjuster 55 is disposed vertically above the maximum water level (shown in FIG. 10B) of the moisturizing liquid.

The partitions 56 and 57 are flat plates which vertically connect the upper wall of the tank 51 with the lower wall of the tank 51. The partitions 56 and 57 have, at their side faces, rectangular notches 56x and 57x, respectively. The notches 56x and 57x are formed in regions including the maximum water level (shown in FIG. 10B) of the moisturizing liquid. The upper end of the partition 56 is disposed between the two protruding portions 51c and one protruding portion 51b. The partition 57 is disposed on the side opposite to the flow adjuster 55 over the partition 56 in the main scanning direction.

The flow adjuster 55 and the partitions 56 and 57 are fixed to a pair of side walls of the tank 51. The paired side walls extend in directions in parallel to the surface of FIG. 10B and oppose each other in the direction vertical to the surface of FIG. 10B. One of the paired side walls, which is not shown in FIG. 10A and FIG 10B, may be a thin film.

The flow of air in the space 51V is indicated by thick arrows in FIG. 10B. The air having flown into the space 51V through each inflow opening 51a1 moves down in the chamber 51R1 and then moves to the chamber 51R2 along the bended shape of the flow adjuster 55. In so doing, the air passes through a relatively narrow space between a corner 51px of, the protrusion 51p and a slope 55bx, and moves leftward and downward in FIG. 10B while increasing the flew velocity in the space. The air then moves along the surface of the moisturizing liquid in the chamber 51R2, passes through a space between the upper wall of the partition 56 which defines the notch 56x and the surface of the moisturizing liquid, and then reaches the chamber 51R3. The air having reached the chamber 51R3 moves upward and flows out from the space 51V through each outflow opening 51e1.

As such, the air having flown into the space 51V through each inflow opening 51a1 is guided by the flow adjuster 55 and a part of the partition 56 which part is vertically above the notch 56x toward the outflow opening 51c1 along the surface of the moisturizing liquid. The air then flows out from the space 51V towards the outflow path 52cf through each outflow opening 51c1 without passing through the moisturizing liquid stored in the space 51V.

It is noted that the chamber 51R4 is not a space in which the air actively flows during the moisturization operation but a space which receives the moisturizing liquid when the tank 51 is tilted on account of, for example, the movement of the printer 1.

As described above, in the printer 1 of the present embodiment because both the inflow Opening 51a1 and the outflow opening 51c1 are positioned vertically above the surface of the moisturizing liquid stored in the space 5W, the generation of bubbles and splash droplets of the moisturizing liquid in the tank is restrained and hence the destruction of the meniscus is restrained.

The flow adjuster 55 and the part of the partition 56 vertically above the notch 56x are disposed vertically above the surface of the moisturizing liquid, between the inflow opening 51a1 and the outflow opening 51c1 . According to this arrangement, on account of the members 55 and 56, the airflow along the surface of the moisturizing liquid is formed. In the tank 51, a relatively high humidity is attained around the surface of the moisturizing liquid, and moisturization by the natural evaporation of the moisturizing liquid is easily achieved by the contact with the moisturizing liquid. As the air is guided to this highly humid part, the moisturization is efficiently carried out.

By the slope 55bx of the flow adjuster 55, the air having flown into the space 51V through the inflow opening 51a1 is smoothly guided to the vicinity of the surface of the moisturizing liquid and to the outflow opening 51c1.

The path of the air having flown into the space 51V through the inflow opening 51a1 which is defined by the flow adjuster 55, is narrowed by the slope 55bx. According to this arrangement, because the flow velocity of the air increases at the slope 55bx, the air is further smoothly guided to the vicinity of the surface of the moisturizing liquid.

By the partition 56, the space 51V is divided into spaces such as the space where the inflow opening 51a1 is disposed, the space where the outflow opening 51e1 is disposed, and the space where the atmosphere opening 51b1 is disposed, and the air is guided to the vicinity, of the moisturizing liquid.

The partition 56 is fixed to both of the paired side walls of the tank 51, so that the rigidity of the tank 51 is improved.

The atmosphere opening 51b1 is disposed between the inflow opening 51a1 and the outflow opening 51c1. With this, even if the tank 51 is tilted on account of, for example, the movement of the printer 1, the moisturizing liquid does not easily flows into the atmosphere opening 51b1.

In the vertical direction, the flow adjuster 55 is interposed between the atmosphere opening 51b1 and the surface of the moisturizing liquid. According to this arrangement, on account of the presence of the flow adjuster 55, it is possible to certainly restrain the moisturizing liquid from flowing into the atmosphere opening 51b1.

When the capping mechanism 40 is in the uncapped state, the controller 1p controls the valves 51bv, 52av, and 52ev so that the inflow path 52af, the outflow path 52cf, and the atmosphere connection path 51bf are closed. According to this arrangement, it is possible to prevent the moisturizing liquid in the tank 51 from being decreased for the reason that the liquid having been evaporated in the tank 51 flows out from the tank 51.

When the capping mechanism 40 is in the capped state and the moisturizing pump 50P is not driven, the controller 1p controls the valves 51bv, 52av, and 52cv so that the inflow path 52af, the outflow path 52cf, and the atmosphere connection path 51bf are opened. This arrangement makes it possible to maintain the pressure in the ejection space V1 to be identical with the atmospheric pressure. With this, the destruction of the meniscus on account of a change in the pressure in the ejection space V1 and liquid leakage through the ejection opening 14a are restrained.

When the capping mechanism 40 is in the capped state and the moisturizing pump 50P is driven, the controller 1p controls the valves 51bv, 52av, and 52cv so that the inflow path 52af, the outflow path 52cf, and the atmosphere connection path 51bf are opened. This arrangement makes it possible to maintain the pressure in the ejection space V1 to be identical with the atmospheric pressure. With this, the destruction of the meniscus on account of a change in the pressure in the ejection space V1 and liquid leakage through the ejection opening 14a are restrained.

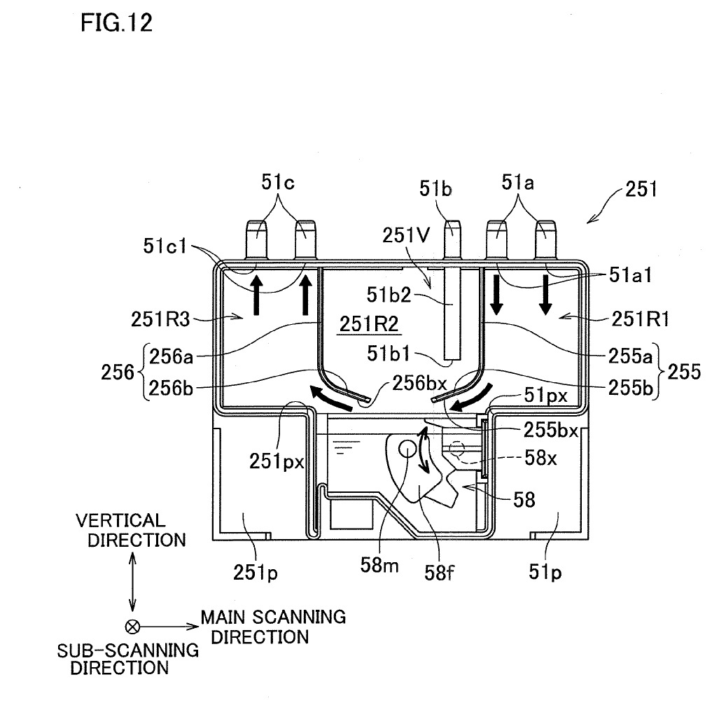

Now, referring to FIG. 12, an inkjet printer according to Second Embodiment of the present invention will be described. The printer of the present embodiment is substantially identical with the printer 1 of the First Embodiment except the structure of the tank. Elements which are the same as those of First Embodiment are designated by the same reference numerals, and redundant descriptions thereof are omitted.

In the present embodiment, a space 251V in a tank 251 is divided into three chambers 251R1, 251R2, and 251R3 by two flow adjusters 255 and 256. The chambers 251R1 and 253R are smaller than the chamber 251R2, i.e., more or less identical with an upper half of the chamber 251R2 in size, because protrusions 51p and 251p which are substantially identical in size with the chambers 251R1 and 251R3 are disposed vertically below the chambers 251R1 and 253R. The moisturizing liquid is stored in a lower part of the chamber 251R2.

The flow adjusters 255 and 256 are bended plates in the same manner as the flow adjuster 55 of the First Embodiment, and include vertical parts 255a and 256a and inclined parts 255b and 256b, respectively. Each of the vertical parts 255a and 256a extends vertically downward from the upper wall of the tank 251 in the same manner as the vertical part 55a of First Embodiment. The inclined part 255b extends in a direction formed by a direction component running from the inflow opening 51a1 toward the outflow Opening 51c1 (leftward in FIG. 12) and a direction component running vertically downward, in the same manner as the inclined part 55b of First Embodiment. In the meanwhile, the inclined part 256b extends in a direction formed by a direction component running from the outflow opening 5101 toward the inflow opening 51a1 (rightward in FIG. 12) and a direction component running vertically downward.

When viewed in the sub-scanning direction, the flow adjusters 255 and 256 are symmetrically arranged about the center line of the tank 251. Furthermore, the air path in a space 251V formed by the outer wall of the tank 251 and the flow adjusters 255 and 256 is symmetrical in shape about the center line of the tank 251, when viewed in the sub-scanning direction. The center line extends in the vertical direction while passing through the center of the tank 251 with respect to the main scanning direction.

The flow adjuster 255 has, at its lower end, a slope (lower surface of the inclined part 255b) 255bx which is inclined in a direction formed by a direction component running from the inflow opening 51a1 toward the outflow opening 51c1 (leftward in FIG. 12) and a direction component running vertically downward. The flow adjuster 256 has, at its lower end, a slope (lower surface of the inclined part 256b) 256bx which is inclined in a direction formed by a direction component running from the outflow opening 5161 toward the inflow opening 51a1 (rightward in FIG. 12) and a direction component running vertically downward. The flow adjusters 255 and 256 are disposed vertically above the maximum water level (shown in FIG. 12) of the moisturizing liquid, between the inflow opening 51a1 and the outflow opening 51c1.

The airflow in the space 251V is indicated by thick arrows in FIG. 12. The air having flown into the space 251V through each inflow opening 51a1 moves down in the chamber 251R1 and then moves to the chamber 251R2 along the bended shape of the flow adjuster 255. In so doing, the air passes through a relatively narrow space between a corner 51px of the protrusion 51p and a slope 255bx, and moves leftward and downward in FIG. 12 while increasing the flow velocity in the space. The air then moves along the surface of the moisturizing liquid in the chamber 251R2, passes through a relatively narrow space between the corner 251px of the protrusion 251p and the slope 256bx while increasing the flow velocity in this space, and then moves leftward and upward in FIG. 12 and reaches the chamber 251R3. The air having reached the chamber 251R3 moves upward and flows out from the space 251V through each outflow opening 51c1.

As such, the air having flown into the space 251V through each inflow opening 51a1 is guided by the flow adjusters 255 and 256 along the surface of the moisturizing liquid toward the outflow opening 51c1. The air then flows out from the space 251V towards the outflow path 52cf through each outflow opening 51c1 without passing through the moisturizing liquid stored in the space 251V.

When the flow of the air generated by the moisturizing pump 50P is reversed, the airflow in the space 251V in the tank 251 becomes in reverse to the direction indicated by the thick arrows in FIG. 12. That is to say, the air having flown into the space 251V through each, outflow opening 51c1 moves down in the chamber 251R3 and then moves to the chamber 251R2 along the bended shape of the flow adjuster 256. In so doing, the air passes through a relatively narrow space between a corner 251px of the protrusion 251p and a slope 256bx, and moves rightward and downward in FIG. 12 while increasing the flow velocity in the space; The air then moves along the surface of the moisturizing liquid in the chamber 251R2, passes through a relatively narrow space between the corner 51px of the protrusion 51p and the slope 255bx while increasing the flow velocity in this space, and then moves rightward and upward in FIG. 12 and reaches the chamber 251R1. The air having reached the chamber 251R1 moves upward and flows out from the space 251V through each inflow opening 51a1.

In the case above, the air having flown into the space 251V through each outflow opening 51c1 is guided by the flow adjusters 255 and 256 along the surface of the moisturizing liquid toward the inflow opening 51a1. The air then flows out from the space 251V towards the inflow path 52af through each inflow opening 51a1 without passing through the moisturizing liquid stored in the space 251V.

As described above, in addition to the effects produced by the arrangements identical with those of First Embodiment, the printer of the present embodiment exerts the effect below because in the space 251V the shape of the air path when the airflow is reversed corresponds to the shape of the air path when the airflow is not reversed. That is to say, the ejection space V1 is uniformly moisturized by the reversal of the airflow, and even when the airflow is reversed, the air flows along the surface of the moisturizing liquid on account of the presence of the flow adjusters 255 and 256, and hence the moisturization is efficiently done.

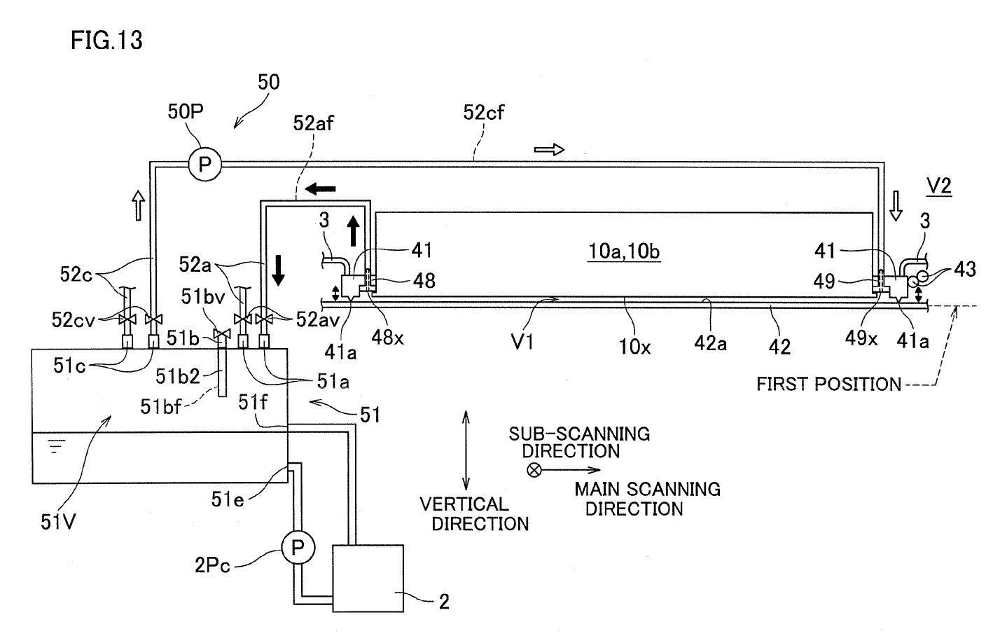

The liquid ejection apparatus is not limited to the printer but, may be a facsimile machine, a photocopier, or the like, The housing of the liquid ejection apparatus is not necessarily composed of two, i.e., upper and lower housings. The housing may be a single housing. The number of heads in the liquid ejection apparatus is any arbitrary number not smaller than one. When more than one head is included in the liquid ejection apparatus, a tank may be provided for each head. The head may eject any type of liquid different from black ink and preprocessing liquid. The head is not necessarily a line-type head but may be a serial-type head. The recording medium is not limited to a sheet P but may be any type of recordable medium. In the embodiment above, the ejection space may be separated from the space surrounding the same for the reason that the annular member 41 contacts not the opposing member 42 but a supporting member (a platen, a conveyance belt, or the like) supporting a recording medium. Furthermore, the capping mechanism is not necessarily composed of a plurality of members (such as the annular member 41 and the opposing member 42 in the embodiment above). For example, the capping mechanism may be: constituted by a single concave member which has, on its upper surface, a concave portion which is substantially identical in size with the ejection surface. The tank may be, provided with a heater for heating the moisturizing liquid. The water level sensor 58 may not be provided as shown in FIG. 13. In such a case, a discharge opening 51f for discharging liquid to the cartridge 2 may be disposed slightly vertically above the maximum water level and a supply opening 51 e for supplying liquid from the cartridge 2 may be disposed below the discharge opening 51f. When the moisturizing liquid supplied from the moisturizing liquid container of the cartridge 2 to the space 51y via the supply opening 51c by the driving of the pump 2Pc exceeds the maximum water level, the moisturizing liquid may be discharged through the discharge opening 51f and return the moisturizing liquid container of the cartridge 2. The valves for opening and closing the inflow path, the outflow path, the atmosphere connection path or the like may not be provided. The ventilator may be disposed on the inflow path or the outflow path; or on both of these paths. The guide may be formed by an outer wall of the tank. For example, in First and Second Embodiments, the upper space of the chamber 51R2 or 251R2 is excluded from the space 51V or 251V and the excluded space functions as a concave portion of the outer wall of the tank 51 or 251. In this case, the outer wall of the tank 51 in First Embodiment is constituted by the flow adjuster 55, a part of the partition 56 which part is vertically above the notch 56x, and a part filling the gap of these members. The outer wall of the tank 251 in Second Embodiment is constituted by the flow adjusters 255 and 256 and a part filling the gap between these members. The guide may not be disposed, in the vertical direction, between the atmosphere opening and the surface of the moisturizing liquid. The path of the air having flown into the tank through the inflow opening, which is defined by the flow adjuster, may not be narrowed by the slope.

For example, as a variation of First Embodiment, the protrusion 51p is not provided and the moisturizing liquid is stored in the space Where the protrusion 51p is disposed in First Embodiment. In this case, while the path is not narrowed at the slope 55bx, the air having flown into the space 51V through the inflow opening 51a1 is guided by the flow adjuster 55 toward the outflow opening 51c1 along the surface of the moisturizing liquid. The guide may be constituted only by a vertically-extending partition without including a flow adjuster having a slope. The guide may not be provided. In First Embodiment, the partition 57 and the chamber 51R4 may not be provided. The position of the atmosphere opening may not be between the inflow opening and the outflow opening. The atmosphere connection path may not be provided.

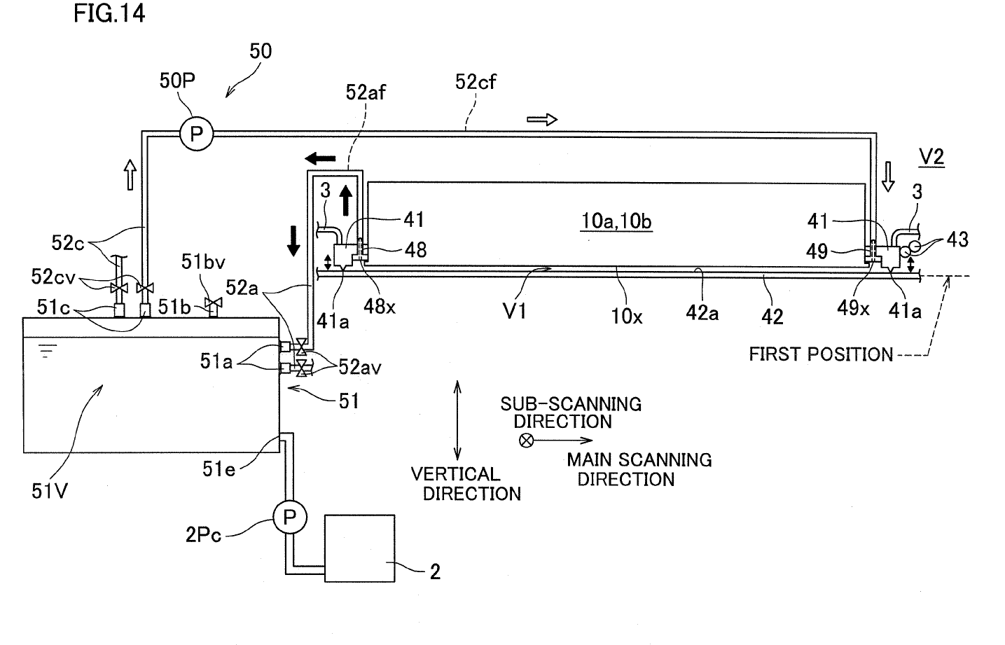

Now, referring to FIG. 14, an inkjet printer according to Third Embodiment of the present invention will be described. The printer of the present embodiment is substantially identical with the printer 1 of First Embodiment except the structure Of the tank 51. Elements which are the same as those of First Embodiment are designated by the same reference numerals, and redundant descriptions thereof are omitted.

In the present embodiment, being different from First Embodiment, two protruding portions 51a are disposed on a side face of the tank 51. An opening (inflow opening) 51a1 at the proximal end of the protruding portion 51a is disposed at the side face of the tank 51 and on an upper half of the chamber 51R1. Being different from First Embodiment, the water level sensor 58 is not provided.

Below the inflow opening 51a1, a supply opening 51e is provided for supplying liquid from the cartridge 2. When a user purchases the printer, no moisturizing liquid is stored in the space 51V in the tank 51. As the user attaches the cartridge 2 to the printer, the pump 2Pc is driven for a first predetermined time so that the moisturizing liquid is supplied from the moisturizing liquid container of the cartridge 2 to the space 51V via the supply opening 51e. The first predetermined time is determined in advance through experiment so that the water level at this time is above the inflow opening 51a1.

Thereafter, as the moisturizing pump 50P of the moisturizing unit 50 is driven and the moisturizing operation is conducted, the moisturizing liquid in the space 51V is reduced substantially in proportion to the increase in the driving time of the moisturizing pump 50P. When the moisturizing liquid in the space 51V almost runs out, the pump 2Pc is driven for the first predetermined time so that the water level of the moisturizing liquid becomes higher than the inflow opening 51a1. Because no water level sensor 58 is provided in the present embodiment, whether the moisturizing liquid almost runs out or not is determined based on whether the moisturizing pump 50P has been driven for a second predetermined time which is determined in advance through experiment.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A liquid ejection apparatus comprising:
a head comprising an ejection surface in which a plurality of ejection openings for ejecting liquid are formed;
a tank configured to store moisturizing liquid;
an inflow path which connects a space in the tank with an ejection space opposing the ejection surface, and configured to allow air flow from the ejection space towards the tank passing through the inflow path, an inflow opening of the inflow path opening to the space in the tank;
an outflow path which connects the space in the tank with the ejection space, and configured to allow air flow from the tank towards the ejection space passing through the outflow path, an outflow opening of the outflow path opening to the space in the tank; and
a ventilator configured to move the air in the inflow path to the space in the tank and to move the air in the outflow path to the ejection space, wherein:
the inflow opening and the outflow opening are vertically above a maximum level of the moisturizing liquid allowed to be stored in the tank.

2. The liquid ejection apparatus according to claim 1, further comprising a guide configured to guide the air having flown into the tank through the inflow opening toward the outflow opening along the surface of the moisturizing liquid, wherein:
the guide is disposed vertically above the maximum level of the moisturizing liquid between the inflow opening and the outflow opening.

3. The liquid ejection apparatus according to claim 2, wherein:
the guide comprises a flow adjuster at a vertically lower end of which a slope is disposed, the slope being inclined in a direction formed by a direction component running from the inflow opening toward the outflow opening and a direction component running vertically downward,

4. The liquid ejection apparatus according to claim 3, wherein:
a path of the air flowing into the tank through the inflow opening, which path is defined by the flow adjuster, is narrowed by the slope.

5. The liquid ejection apparatus according to claim 2, wherein:
the guide comprises a partition which vertically extends and divides the space in the tank into a plurality of spaces.

6. The liquid ejection apparatus according to claim 5, wherein:
the partition is fixed to both of paired side walls of the tank.

7. The liquid ejection apparatus according to claim 1, further comprising a controller configured to control the ventilator to reverse the flow of the air generated by the ventilator, to cause the air flow from the ejection space towards the tank to pass through the outflow path and to cause the air flow from the tank towards the ejection space to pass through the inflow path, wherein:
a path of the air in the tank when the flow of the air is reversed corresponds in shape to a path of the air in the tank when the flow of the air is not reversed.

8. The liquid ejection apparatus according to claim 1, further comprising an atmosphere connection path which connects the space in the tank with the atmosphere, wherein:
an atmosphere opening of the atmosphere connection path, which opens to the space in the tank, is disposed between the inflow opening and the outflow opening.

9. The liquid ejection apparatus according to claim 8, wherein:
in a vertical direction, a guide is disposed between the atmosphere opening and the maximum level of the moisturizing liquid, the guide configured to guide the air having flown into the tank through the inflow opening toward the outflow opening along the surface of the moisturizing liquid.

10. The liquid ejection apparatus according to claim 1, further comprising:
an atmosphere connection path which connects the space in the tank with the atmosphere;
a plurality of valves configured to open or close the inflow path, the outflow path, and the atmosphere connection path, respectively;
a capping mechanism configured to selectively take a capped state in which the ejection space is covered or an uncapped state in which the ejection space is not covered; and
a controller configured to control the valves to close the inflow path, the outflow path, and the atmosphere connection path when the Capping mechanism is in the uncapped state.

11. The liquid ejection apparatus according to claim 1, further comprising:
an atmosphere connection path which connects the space in the tank with the atmosphere;
a plurality of valves configured to open or close the inflow path, the outflow path, and the atmosphere connection path, respectively;
a capping mechanism configured to selectively take a capped state in which the ejection space is covered or an uncapped state in which the ejection space is not covered; and
a controller configured to control the valves to open the inflow path, the outflow path, and the atmosphere connection path when the capping mechanism is in the capped state and the ventilator is not driven.

12. The liquid ejection apparatus according to claim 1, further comprising:
an atmosphere connection path which connects the space in the tank with the atmosphere;
a plurality of valves configured to open or close the inflow path, the outflow path, and the atmosphere connection path, respectively;
a capping mechanism configured to selectively take a capped state in which the ejection space is covered or an uncapped state in which the ejection space is not covered; and
a controller configured to control the valves to open the inflow path, the outflow path, and the atmosphere connection path when the capping mechanism is in the capped state and the ventilator is driven.

13. The liquid ejection apparatus according to claim 1, further comprising:
a level sensor configured to detect a level of moisturizing liquid stored in the tank;
a supplying device which connects the tank and configured to supply the tank with the moisturizing liquid; and
a controller configured to control the supplying device to supply the tank with the moisturizing liquid based on the detection result of the level sensor such that the inflow opening and the outflow opening are vertically above a level of the moisturizing liquid stored in the tank.

14. The liquid ejection apparatus according to claim 1, wherein:
the tank is configured to discharge moisturizing liquid through a discharge opening disposed at a side surface of the tank; and
the inflow opening and the outflow opening are vertically above the discharge opening.

15. The liquid ejection apparatus according to claim 1, further comprising:
a capping mechanism configured to selectively take a capped state in which the ejection space is covered or an uncapped state in which the ejection space is not covered; and
a controller configured to drive the ventilator while maintaining the capping mechanism to be in the capped state when the ejection space is moisturized.

16. The liquid ejection apparatus according to claim 1, wherein:
the air having flown into the tank through the inflow opening flows out to the outflow path through the outflow opening without passing through the moisturizing liquid stored in the tank.

17. A liquid ejection apparatus comprising:
a head comprising an ejection surface in which a plurality of ejection openings for ejecting liquid are formed;
a tank configured to store moisturizing liquid;
an inflow path which connects a space in the tank with an ejection space opposing the ejection surface, and configured to allow air flow from the ejection space towards the tank passing through the inflow path, an inflow opening of the inflow path opening to the space in the tank;
an outflow path which connects the space in the tank with the ejection space, and configured to allow air flow from the tank towards thee ejection space passing through the outflow path, an outflow opening of the outflow path opening to the space in the tank; and
a ventilator configured to move the air in the inflow path to the space in the tank and to move the air in the outflow path to the ejection space, wherein:
the inflow opening and the outflow opening are disposed at an upper half portion of the tank.

18. The liquid ejection apparatus according to claim 17, wherein the inflow opening and the outflow opening are disposed at a top surface of the tank.

19. A liquid ejection apparatus comprising:
a head comprising an ejection surface in which a plurality of ejection openings for ejecting liquid are formed;
a tank configured to store moisturizing liquid;
an inflow path which connects a space in the tank with an ejection space opposing the ejection surface, and configured to allow air flow from the ejection space towards the tank passing through the inflow path, an inflow opening of the inflow path opening to the space in the tank;
an outflow path which connects the space in the tank with the ejection space, and configured to allow air flow from the tank towards the ejection Space passing through the outflow path, an outflow opening of the outflow path opening to the space in the tank;
a ventilator configured to move the air in the inflow path to the space in the tank and to move the air in the outflow path to the ejection space;
a level sensor configured to detect a level of moisturizing liquid stored in the tank;
a supplying device which connects the tank and configured to supply the tank with the moisturizing liquid; and
a controller configured to control the supplying device to supply the tank with the moisturizing liquid based on the detection result of the level sensor such that the inflow opening and the outflow opening are vertically above a level of the moisturizing liquid stored in the tank.

20. A liquid ejection apparatus comprising:
a head comprising an ejection surface in which a plurality of ejection openings for ejecting liquid are formed;
a tank configured to store moisturizing liquid and to discharge moisturizing liquid through a discharge opening disposed at a side surface of the tank;
an inflow path which connects a space in the tank with an ejection space opposing the ejection surface, and configured to allow air flow from the ejection space towards the tank passing through the inflow path, an inflow opening of the inflow path opening to the space in the tank;
an outflow path which connects the space in the tank with the ejection space, and configured to allow air flow from the tank towards the ejection space passing through the outflow path, an outflow opening of the outflow path opening to the space in the tank; and
a ventilator configured to move the air in the inflow path to the space in the tank and to move the air in the outflow path to the ejection space, wherein;
the inflow opening and the outflow opening are vertically above the discharge opening.
